(19) United States
(12) Patent Application Publication
(10) Pub. No.: US 2013/0083967 A1
(43) Pub. Date: Apr. 4, 2013

(54) System and Method for Extracting Features in a Medium from Data Having Spatial Coordinates

(71) Applicants: Boris Vorobiov, Gloucester (CA); Oleksandr Monastyrev, Kharkiv (UA)

(72) Inventors: Boris Vorobiov, Gloucester (CA); Oleksandr Monastyrev, Kharkiv (UA)

(73) Assignee: AMBERCORE SOFTWARE INC., Ottawa, ON (CA)

(21) Appl. No.: 13/700,057

(22) PCT Filed: May 26, 2011
(86) PCT No.: PCT/CA2011/000602

§ 371 Date: Nov. 26, 2012

Related U.S. Application Data
(60) Provisional application No. 61/348,476, filed on May 26, 2010.

(51) Int. Cl. G06T 7/00

(52) U.S. Cl. CPC G06T 7/0075
USPC 382/103

(57) ABSTRACT

Systems and methods are provided for extracting various features from data having spatial coordinates. Based on a few known data points in a point cloud, other data points can be interpolated for a given parameter using probabilistic methods, thereby generating a greater number of data points. Using the greater number of data points, a Boolean function, related in part to the given parameter, can be used to extract more detailed features. Based on the Boolean values, a shape of a body having the characteristic(s) defined by the Boolean function can be constructed in a layered manner. The extraction of the features may be carried out automatically by a computing device.

### CROSS-REFERENCE TO RELATED APPLICATIONS

The present application claims priority to U.S. Patent Application No. 61/348,476 filed on May 26, 2010, which is hereby incorporated by reference in its entirety.

### TECHNICAL FIELD

The following relates generally to extracting features from data representing spatial coordinates.

### DESCRIPTION OF THE RELATED ART

In order to investigate a body of mass or an area of space, it is known to interrogate the mass or the space and collect data resulting from the interrogation. The nature of the interrogation will depend on the characteristics of the mass or the space. The interrogation will typically be a scan by a beam of energy propagated under controlled conditions. The results of the scan are stored as a collection of data points, and the position of the data points in an arbitrary frame of reference is encoded as a set of spatial-coordinates. In this way, the relative positioning of the data points can be determined and the required information extracted from them.

Data having spatial coordinates may include data collected by electromagnetic sensors of remote sensing devices, which may be of either the active or the passive types. Non-limiting examples include LiDAR (Light Detection and Ranging), RADAR, SAR (Synthetic-aperture RADAR), IFSAR (Interferometric Synthetic Aperture Radar) and Satellite Imagery. Other examples include various types of 3D scanners and may include sonar and ultrasound scanners.

In other applications, for example related to mining and drilling, the interrogation will typically be a core sample. A drill will extract material from ground surface, or below the ground, and will record the location, or spatial coordinates, from where the material was extracted. Therefore, when the data is obtained about the extracted material, the data will be associated with the spatial coordinates. The data, or data points, that are related to the collected material can then be spatially mapped in a coordinate frame. In other applications, bodies of water, regions of atmosphere or gas, or samples of a rock can be interrogated by taking sample data associated with spatial coordinates. In such applications, it can be especially difficult to collect data due to limited access points (e.g. the ground surface, the water surface, etc.).

The collection of data points having spatial data can be generally referred to as a point cloud. The visualization of point cloud data can reveal information about the various objects which have been scanned. Information can also be manually extracted from the point cloud data and represented in other forms such as 3D vector points, lines and polygons, or as 3D wire frames, shells and surfaces. These forms of data can then be input into many existing systems and workflows for use in many different industries including for example, engineering, mining, environmental management, drilling, construction and surveying.

A common approach for extracting these types of information from 3D point cloud data involves subjective manual pointing at points representing a particular feature within the point cloud data either in a virtual 3D view or on 2D plans, cross sections and profiles. The collection of selected points is then used as a representation of an object. Some semi-automated software and CAD tools exist to streamline the manual process including snapping to improve pointing accuracy and spline fitting of curves and surfaces. Such a process is tedious and time consuming. The complexity of the process is even more apparent when there are few data points. This may be typical in applications where gathering data points is costly and time consuming. For example, obtaining core samples of the ground requires drilling, which can be difficult, therefore drastically limiting the number of data points that can be obtained. Accordingly, methods and systems that better semi-automate and automate the extraction of these geometric features from the point cloud data are highly desirable.

Automation of the process is, however, difficult as it is necessary to recognize which data points form a certain type of object. For example, in a mining or drilling application, where it is desirable to identify the shape and location of ore or mineral bodies (e.g. masses of gold, masses of bauxite, masses of quartz, etc.), it can be difficult to identify the boundaries between the ore or mineral bodies. The data points from the different materials coexist within the point cloud and their segregation is not trivial.

From the above it can be understood that efficient and automated methods and systems for identifying and extracting features from 3D spatial coordinate data are highly desirable.

### BRIEF DESCRIPTION OF THE DRAWINGS

Embodiments of the invention or inventions will now be described by way of example only with reference to the appended drawings wherein:

FIG. 1 is a schematic diagram to illustrate an example of drilling holes used to sample material located below a surface.

FIG. 2 is a block diagram of an example embodiment of a computing device and example software components.

FIG. 3 is a schematic diagram to illustrate another example of drilling holes and a volume of material organized into voxels.

FIG. 4 is a schematic diagram illustrating the layers of voxels shown in FIG. 3 in an expanded view, with Boolean values assigned to some of the voxels.

FIG. 5 is a schematic diagram illustrating the boundary lines drawn around certain of the voxels in each layer shown in FIG. 4.

FIG. 6 is a schematic diagram illustrating the boundary lines of FIG. 5 projected onto a horizontal plane.

FIG. 7 is a perspective view of the body of material constructed from the boundary lines of FIG. 5.

FIG. 8 is a flow diagram illustrating example computer executable instructions for constructing a shape of a body of material.

FIG. 9 is a flow diagram illustrating example computer executable instructions continued from FIG. 8.

FIG. 10 is a schematic diagram illustrating the an expanded view of layers of voxels and corresponding boundary lines.

FIG. 11 is a schematic diagram illustrating the boundary lines of FIG. 10 projected onto a horizontal plane.

FIG. 12 is a perspective view of the body of material constructed from the lines of FIG. 10.

FIG. 13 is an example screen-shot of a ground surface and drill holes.

FIG. 14 is an example screen-shot of a ground surface, body of material, and drill holes.

FIG. 15 is a schematic diagram illustrating drilling holes intersecting layer boundaries.

FIG. 16 is a flow diagram illustrating example computer executable instructions for identifying layer boundaries.

FIGS. 17(a), 17(b), and 17(c) illustrate example stages of identifying layer boundaries from drill holes.

FIG. 18 is a flow diagram illustrating example computer executable instructions for determining an interpolated parameter value and confidence level for each voxel.

FIG. 19 is a flow diagram illustrating example computer executable instructions continued from FIG. 18.

FIG. 20 is an example screen-shot of the distinct layers extracted from the voxels, based on the interpolated parameter value and confidence level for each voxel.

FIG. 21 is another example screen-shot of the distinct layers extracted from the voxels, based on the interpolated parameter value and confidence level for each voxel.

FIG. 22 is a schematic diagram illustrating an example of a voxel in which its interpolated parameter value is determined in relation to a drill hole.

FIG. 23 is a flow diagram illustrating example computer executable instructions for determining interpolated values associated with a number voxels and then applying a Boolean function associated with the interpolated values to identify boundary layers.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

In one aspect, a proposed system and method are provided for identifying a body of common material from a data set, whereby the data set corresponds to spatial coordinates and is organized into a three-dimensional array of voxels. In a first and a second layer of voxels, for each voxel, a Boolean function is applied. In the first and the second layer, a first boundary line and a second boundary line are defined around at least one voxel that returned a positive Boolean value. Then the first and the second boundary lines are projected onto a horizontal plane. If the projected boundary lines intersect, then the boundary lines are classified as part of the same body. Then, a shell is created by projecting each boundary line down onto the layer below.

In another aspect, a proposed system and method are provided for interpolating a value of a parameter, whereby the value is associated with a spatial coordinate. Upon determining the spatial coordinate is located in a layer defined by at least a first and a second layer boundary, a distance ratio is then determined. The distance ratio is determined by the spatial coordinate's distance to the first layer boundary and to the second layer boundary. Then, at a drill hole extending across the first and the second layer boundary, a basic point is selected, whereby the basic point is located in the layer and positioned at the distance ratio relative to the first and the second layer boundary. A known value of the parameter, at a known data point in the drill hole, is identified. The value associated with the spatial coordinate is then determined using the known value. The known value will have a higher influence on determining the value to be interpolated, if the known value is closer to the basic point and if the drill hole is closer to the spatial coordinate.

The proposed systems and methods extract features from data having spatial coordinates, and is particularly suitable to extracting features below surfaces. Non-limiting examples of such surfaces include the ground surface, water surface, surface of an object, etc. The extraction of the features may be carried out automatically by a computing device. The extracted features may be stored as objects for retrieval and analysis.

As discussed above, the data may be collected from various types of sensors. A non-limiting example of such a sensor is the LiDAR system built by Ambercore Software Inc. and available under the trade-mark TITAN. Depending on the application, such as for geological applications, the data about the material characteristics may be collected using other known scientific methods.

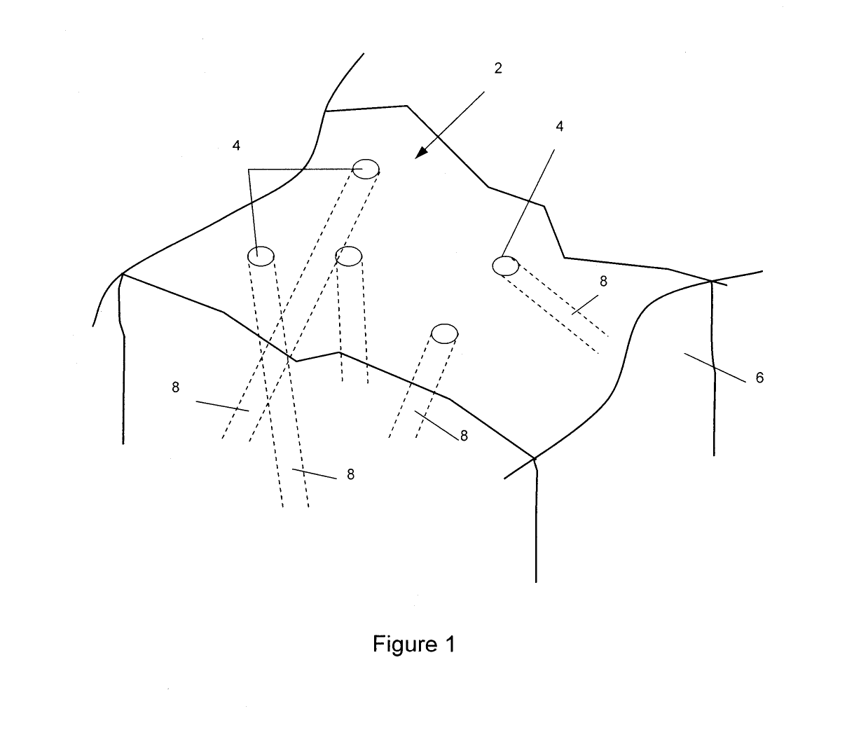

Turning to FIG. 1, a portion of a ground surface 2 is shown as well as a portion of underground or subsurface space 6. In drilling or mining operations, core samples of the ground are obtained through drill holes 8. A core sample is typically a cylindrical section of a naturally occurring medium consistent enough to hold a layered structure. Most cores are obtained by drilling into the medium, for example sediment or rock, with a hollow steel tube called a corer. The hole made for the core sample is called a core hole or drill hole 8. The openings 4 of the drill holes are made at various locations on the surface 2, and drill holes 8 themselves can be angled to provide data or data points about the ground in both a vertical and a horizontal direction. In this way, the number of drill holes 8 can reduced.

More generally, the ground surface 2 can be considered to be any surface (e.g. skin surface of a person, surface of water, etc.) and the drill holes 8 can be considered to be any known or confirmed data that is shaped in a generally elongated and linear-like direction. Therefore, although reference is herein made to drilling applications for consistency, it is understood that the principles described herein are applicable to various other environments.

Each of the collected data points is associated with respective spatial coordinates, in an arbitrary frame of reference, which may be in the form of three dimensional spatial data coordinates, such as XYZ Cartesian coordinates (or alternatively a radius and two angles representing Polar coordinates). Each of the data points also has numeric or classification attributes indicative of a particular characteristic. Examples of such types of data depend on the application, but can include the pH level, the density, the moisture, the rock type, the viscosity of the oil, etc. Such data can be gathered using known scientific methods.

It is appreciated that the location of the drill holes 8 are accurately recorded, for example using GPS, so that data points about the material can be mapped onto or associated with a spatial coordinate. The determination of the coordinates for each data point is performed using known algorithms to combine location data, e.g. GPS data, with the features of the collected core samples to obtain a location of each data point with an arbitrary frame of reference.

In many cases, the core samples are used to also define a shape and location of an object positioned underground, or more generally, below a surface. Examples of such objects are a body of ore, a body of oil, and a pipe. However, as discussed above, based on the difficulty to obtain core samples, the amount of collected data is limited.

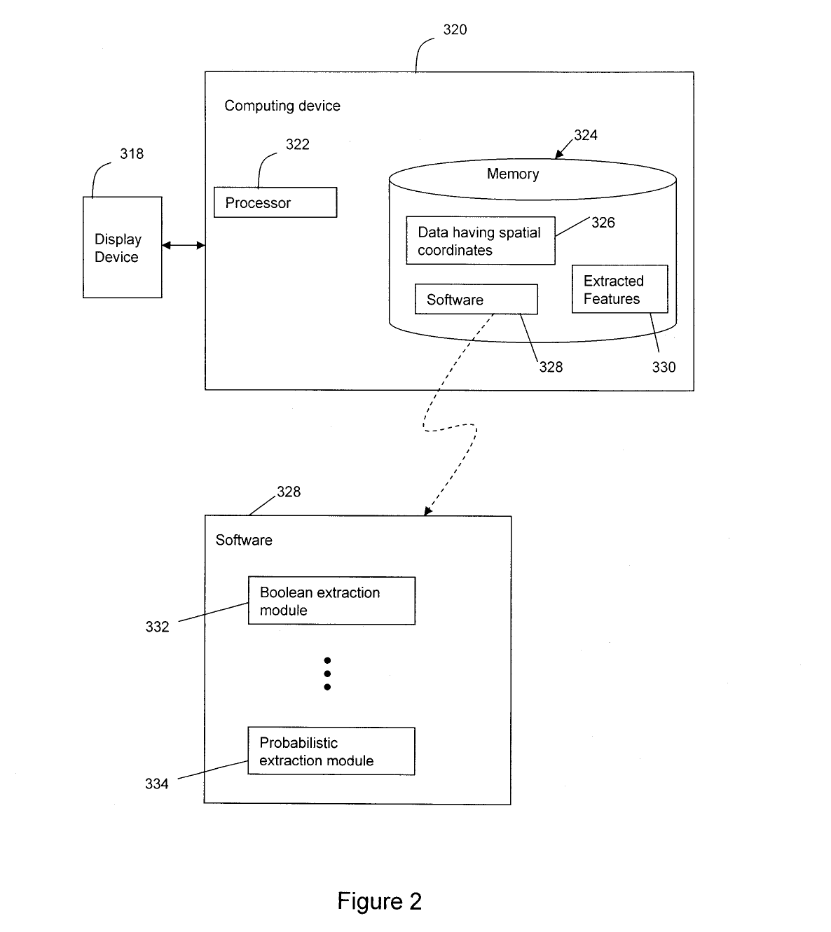

Turning to FIG. 2, a computing device 320 includes a processor 322 and memory 324. The memory 324 communicates with the processor 322 to process data. It can be appreciated that various types of computer configurations (e.g. networked servers, standalone computers, cloud computing, etc.) are applicable to the principles described herein. The data having spatial coordinates 326 and various software 328 reside in the memory 324. A display device 318 may also be in communication with the processor 322 to display 2D or 3D images based on the data having spatial coordinates 326.

It can be appreciated that the data 326 may be processed according to various computer executable operations or instructions stored in the software. In this way, the features may be extracted from the data 326.

Continuing with FIG. 2, the software 328 may include a number of different modules for extracting different features from the data 326. For example, a Boolean extraction module 332 may be used to identify and extract data points about an object based on Boolean type logic. A probabilistic extraction module 334 may include computer executable instructions or operations for identifying and extracting data points based on interpolation. It can be appreciated that there may be many other different modules for extracting features from the data having spatial coordinates 326.

Continuing with FIG. 2, the features extracted from the software 328 may be stored as data objects in an “extracted features” database 330 for future retrieval and analysis. For example, features (e.g. shapes of ore bodies, shapes of pipes, shapes of gas clouds, shapes of oil reservoirs, shapes of an organ in a human body, etc.) that have been extracted from the data (e.g. point cloud) 326 are considered separate entities or data objects, which are stored the database 330. It can be appreciated that the extracted features or data objects may be searched or organized using various different approaches.

It will be appreciated that any module or component exemplified herein that executes instructions or operations may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data, except transitory signals per se. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the computing device 20 or accessible or connectable thereto. Any application or module herein described may be implemented using computer readable/executable instructions or operations that may be stored or otherwise held by such computer readable media.

Details regarding the different feature extraction systems and methods, that may be associated with the various modules in the software 28, will now be discussed.

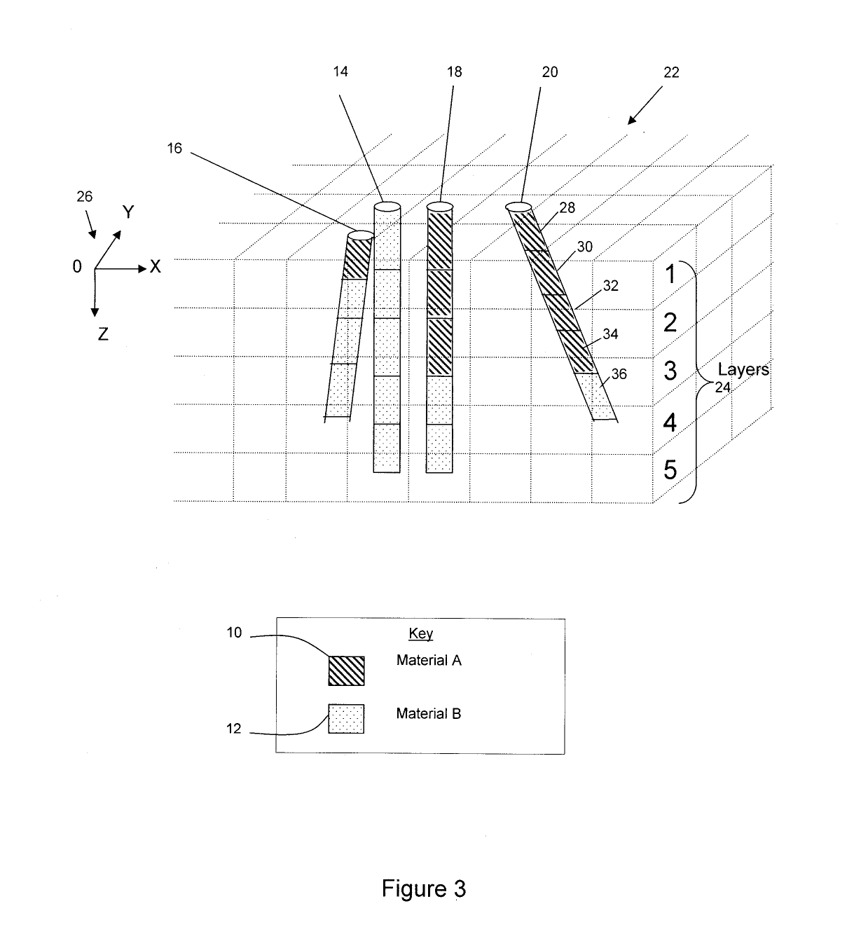

FIGS. 3 to 7 illustrate an example method for identifying the shape of an “object” (e.g. ore body or cloud of gas) from a surface using Boolean-type decision making. Turning to FIG. 3, an example of drill holes 14, 16, 18, 20 are shown in portion of ground 22. The portion of ground 22 is divided into volumetric pixels, also referred to as voxels. A voxel has a depth, width and a length. The dimensions of each voxel can be arbitrary or is typically selected to suit the application. In geological or drilling applications, for example, a voxel can have dimensions of 5 meters by 5 meters in the horizontal XY directions and 1 meter in the vertical direction in order to account for the greater need for higher resolution in the vertical direction. In the portion of ground shown 22, there are five vertical layers 24 of voxels.

The drill holes 16, 14, 18, 20 are in the portion of ground 22 and each of the drill holes is also sectioned into the vertical layers 24. Different shading is used to show different materials identified in drill holes 16, 14, 18, 20. The diagonal shading 10 represents one material (e.g. material A) and the dotted shading 12 represent a different material (e.g. material B). For example, drill hole 20 shows that at the first layer or section 28, second section 30, third section 32 and fourth section 34, the core sample from the drill hole 20 is made of or includes material A. However, at the fifth section 36 of the drill hole 20, as per the different voxel layers 24, material B is located. It can be appreciated that location of a data point, in this case the type of material, is identified by the location of the voxel to which the data points pertains. A frame of reference 26 may also be provided.

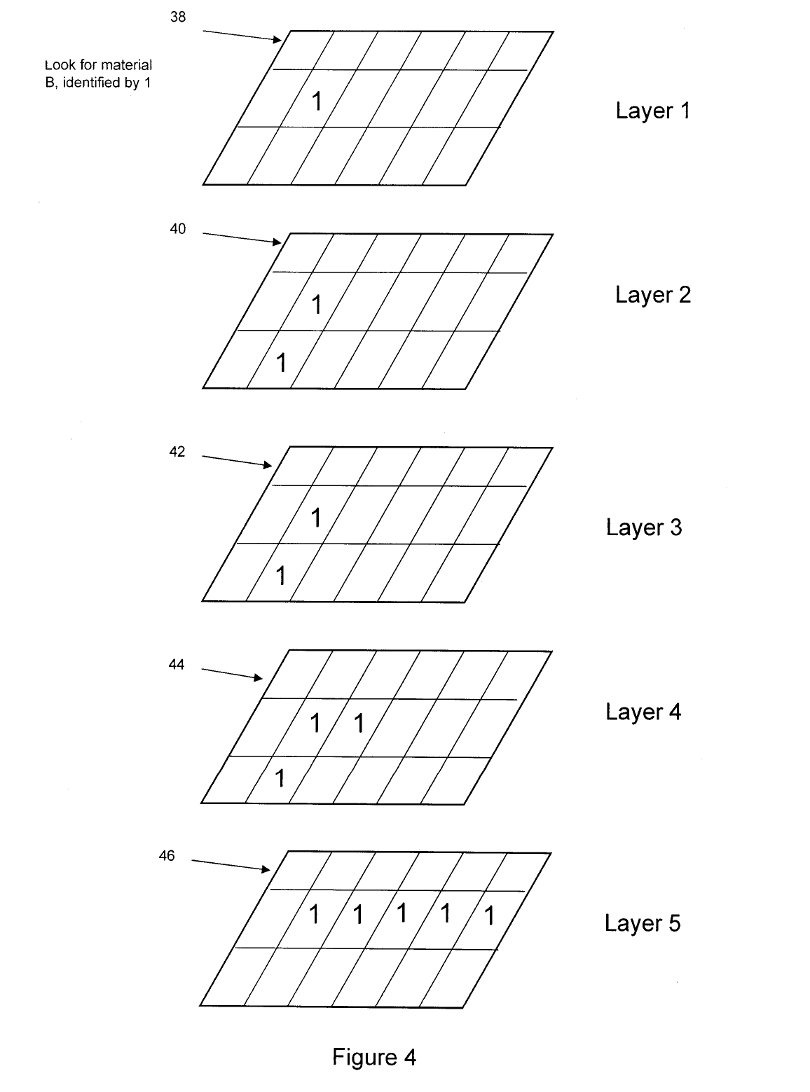

Turning to FIG. 4, each of the five layers from the portion of ground 22, as per FIG. 3, are shown in an exploded view. In this example, it is desired to define the shape of the body made of material B based on the known data points collected from the drill holes. Using the established grid of voxels, for each voxel, a Boolean function is executed to determine whether or not a particular attribute, for example material B, is present. If material B is present at the certain voxel, then the Boolean function returns the value 1 for that attribute. Otherwise, if the attribute (e.g. material B) is not present, then the Boolean function returns the value 0. Therefore, at Layer 1 (reference numeral 38), only one voxel returns a true or 1 value. This Boolean value corresponds with the data point collected from drill hole 14 shown in FIG. 3.

Layer 2 (40) and Layer 3 (42) each show that two voxels, which are side-by-side, have the Boolean value of 1. Layer 4 (44) shows that three voxels, in an L-shaped configuration, have the Boolean values of 1. Layer 5 (46) also shows five adjacent voxels having the Boolean value of 1.

The Boolean evaluation may be performed for a number of attributes with values stored for each iteration for subsequent processing. The types of attributes may vary and can be determined to suit the application.

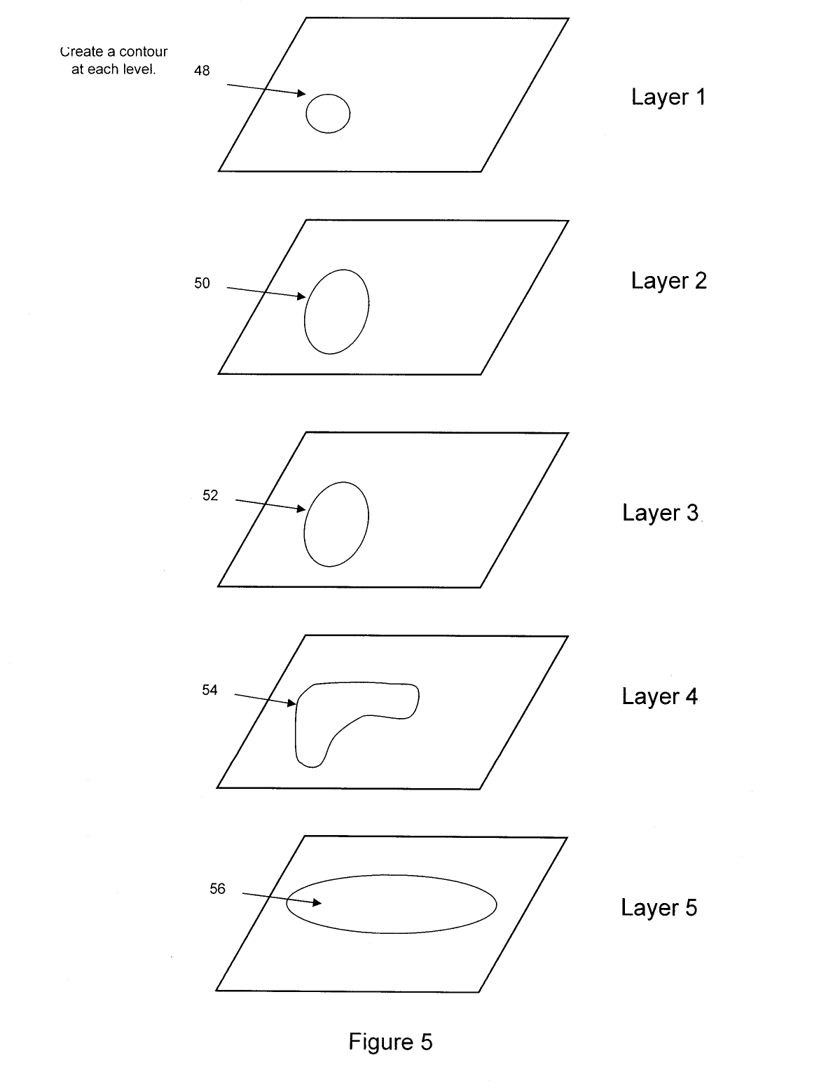

Turning to FIG. 5, for each layer, a boundary line is formed around the voxel or voxels having a Boolean value 1. The boundary line may be calculated by using any known edge detection or perimeter detection methods. Various methods of edge detection or perimeter detection are known in the field of pattern recognition and are applicable to the principles described herein. In the example illustrated in FIG. 5, the boundary lines are contours. In Layer 1, the boundary line 48 is calculated to approximate the area of material B. Similarly, in Layers 2, 3, 4 and 5, boundary lines 50, 52, 54 and 56 are calculated, respectively.

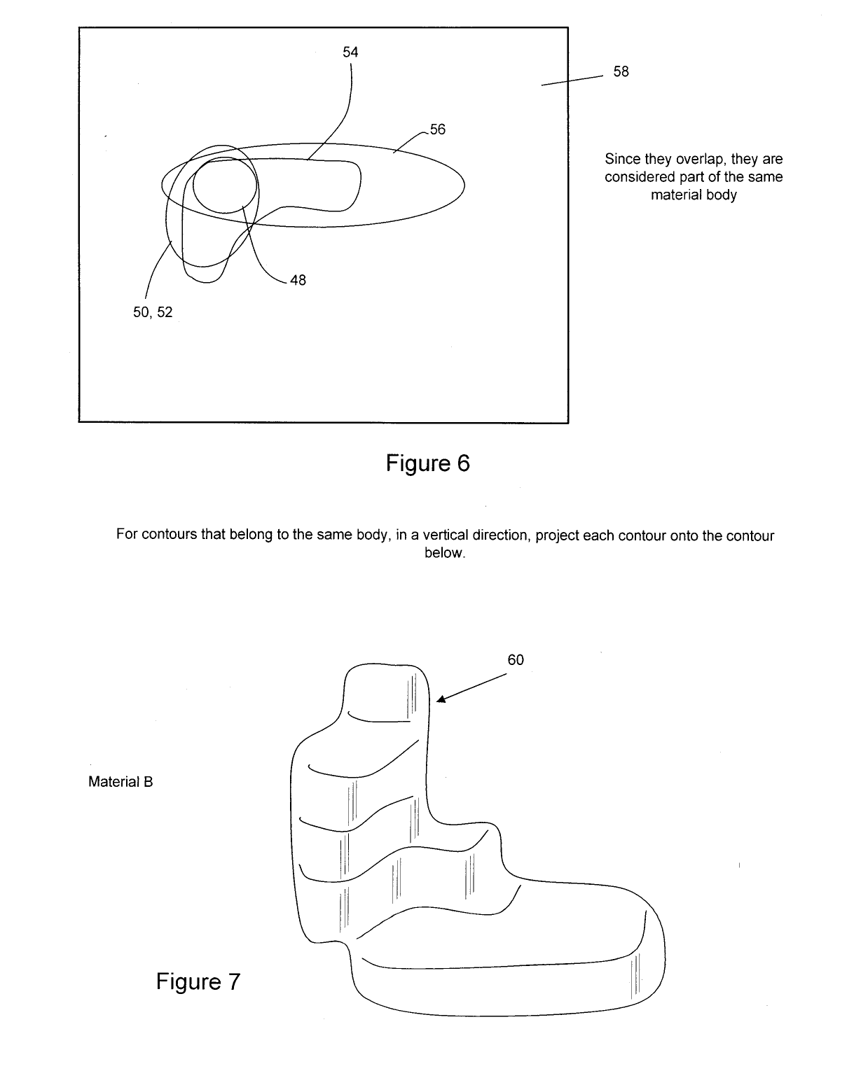

Turning to FIG. 6, the boundary lines 48, 50, 52, 54 and 56 are projected onto a single horizontal plane 58. If it is determined that the boundary lines 48, 50, 52, 54 and 56 overlap with one another, then the boundary lines 48, 50, 52, 54 and 56 are considered to define the perimeter or shape of the same or common body made of material B. This is particularly useful since multiple bodies of the same material can be formed near one another, while still being separate from each other. The method described herein is able to account for such multiple bodies.

Turning to FIG. 7, since the boundary lines 48, 50, 52, 54 and 56 are part of the same body, then these lines can be used to form a unified three-dimensional shape. Known 3D-reconstruction methods can be applied to calculate or form a shell or surface around the boundary lines. In one example method, a boundary line on one layer can be projected downwards onto the layer below, whereby the vertical gaps between the layers are “filled-in”. A 3D-reconstruction of the body 60 made of material B is shown.

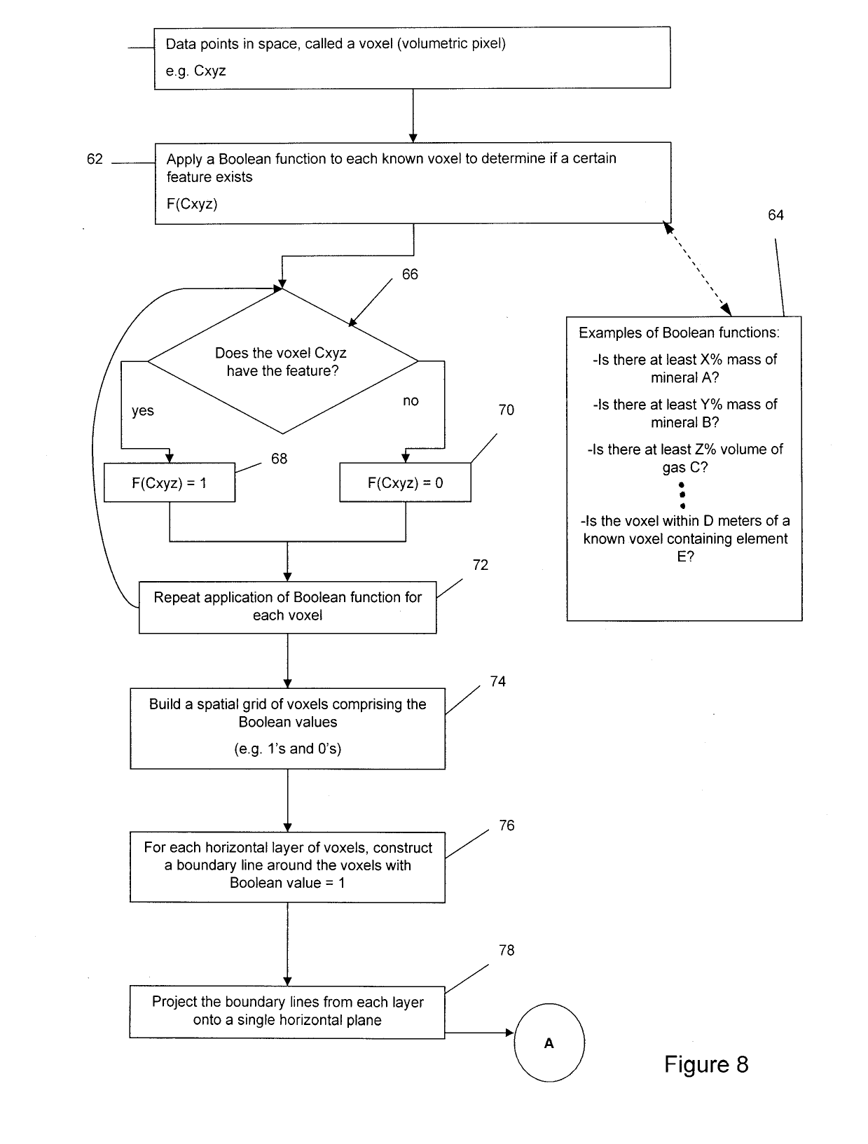

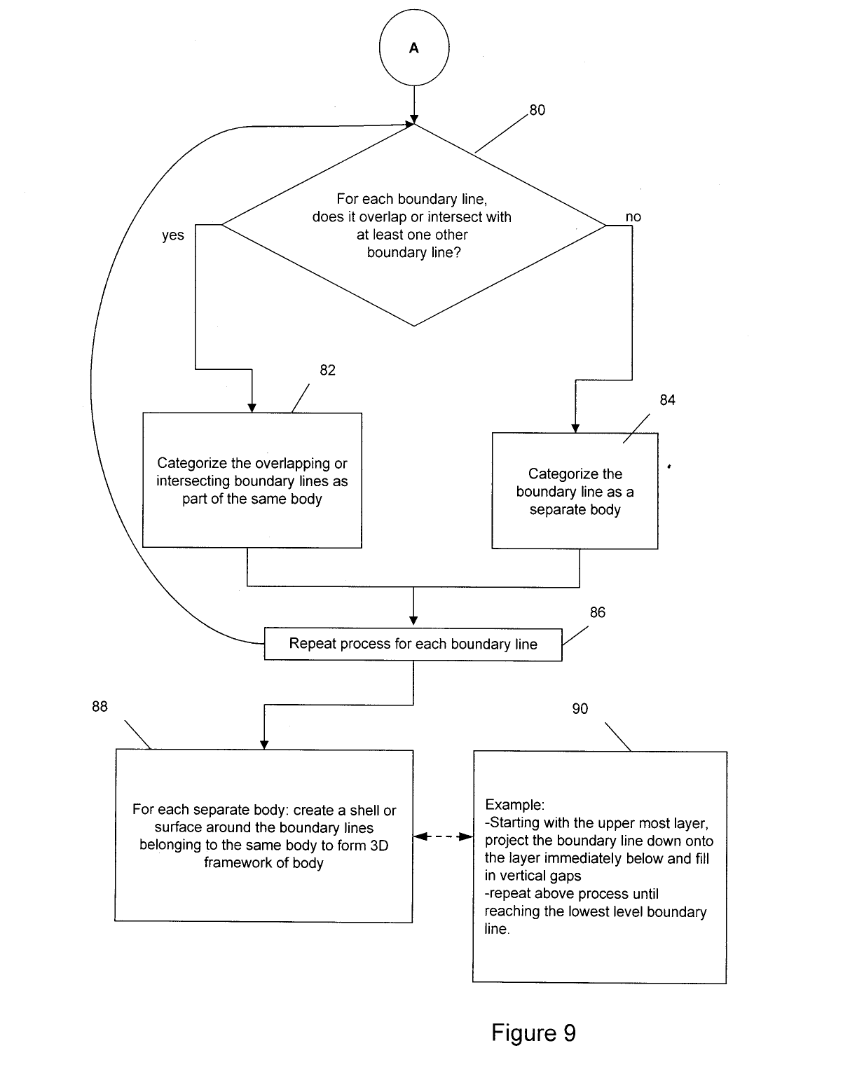

The principles described with respect to the example in FIGS. 3 to 7 are more generally discussed below, with respect to FIGS. 8 and 9. In general, FIGS. 8 and 9 provide example computer executable instructions for extracting the geometric features of a body of material using Boolean-type logic. Such instructions may be part of the Boolean extraction module 332. Generally, the method includes feature marking (e.g. identifying the feature of each voxel using a Boolean function) and feature construction (e.g. analysing the collection of voxels and their corresponding Boolean values to construct features).

In particular, the proposed method identifies a body of common material from a data set, the data set corresponding to spatial coordinates and organized into a three-dimensional array of voxels. The method comprises, in a first and a second layer of voxels, for each voxel, applying a Boolean function. In the first and the second layer, a first boundary line and a second boundary line are defined around at least one voxel that returned a positive Boolean value (e.g. 1). The first and the second boundary lines are projected onto a horizontal plane, and if the boundary lines intersect, the boundary lines are classified as part of the same body.

In FIG. 8, at block 61, a set of data points are provided in segmented space. In particular, the data is associated with a set of voxels in 3D space, whereby each voxel has spatial coordinates (e.g. x,y,z) associated with its centre point. At block 62, a Boolean function is applied to the voxels. Typically, although not necessarily, the Boolean function is only applied to voxels that are known to have data. The Boolean function indicates clearly whether a certain feature or characteristic exists or does not exist in the voxel. Non-limiting examples of Boolean functions are provided in box 64 and include determining if there is at least a certain percentage x of mass for a given material (e.g. gold) within the voxel. In another example, the Boolean function could determine if there is at least certain percentage volume of a gas within the voxel. It could also be determined whether a voxel is within a certain distance from a voxel containing known data (e.g. Is the voxel within 5 meters of a voxel known to have element E?). It can thus be appreciated that various Boolean functions are applicable to the principles described herein and combinations of attributes may be used to allocate a value (e.g. Is there x % of material A and y % of gas?).

Continuing with FIG. 8, at block 66, it is determined whether the certain voxel has the feature as defined by the Boolean function. If so, at block 68, the value 1 is assigned to the voxel. Otherwise, a block 70, the value 0 is assigned. At block 72, the process of assigning the Boolean value is repeated for each voxel in the set of voxels. At block 74, a spatial grid of voxels comprising the Boolean values is built. It can be appreciated that the Boolean values can be 1 and 0, true and false, yes or no, etc. At block 76, for each horizontal layer of voxels, a boundary line is constructed around voxels having a Boolean value of 1. It can be understood, that, depending on the application and the logic of the Boolean function, the boundary line can be constructed around voxels having a Boolean value of 0. At block 78, the boundary lines from each of the different layers are projected onto a single horizontal plane. As indicated by circle A, the method of FIG. 8 continues to FIG. 9.

Continuing with FIG. 9, at block 80, it is determined, for each boundary line, whether the boundary line overlaps or intersects with at least one other boundary based on the projection onto the horizontal plane. If so, at block 82, the certain boundary is categorized as part of the same body as the one or more other boundary lines with which the certain boundary line overlaps. If not, at block 84, the certain boundary line is not considered to be part of the same body. As per block 86, the decision-making process of blocks 80, 82, 84 are repeated fro each boundary line.

At block 88, for each separate body, a shell or surface is formed around the boundary lines that have been categorized as belonging to the same body. In this way, a 3D shape showing the geometric features of the body can be displayed. An example of creating the 3D shape is provided in block 90, whereby the boundary line of the uppermost layer is projected downwards to the layer below and the vertical gaps between the projections are filled in. The process repeats with each consecutively lower layer and ends with the boundary line at the lowest layer.

It can be appreciated that the boundary line of a layer may be projected to the layer immediately below. In some cases, this may create a discontinuity in the body or shape of the body, e.g. in the vertical direction, which may be desirable in certain applications. For example, when attempting to identify the shapes of dinosaur bones, the bones may be fragmented. Using the above principles to generate the shapes, which may be discontinuous segments, the shapes may still be classified as part of the same body, e.g. of a dinosaur.

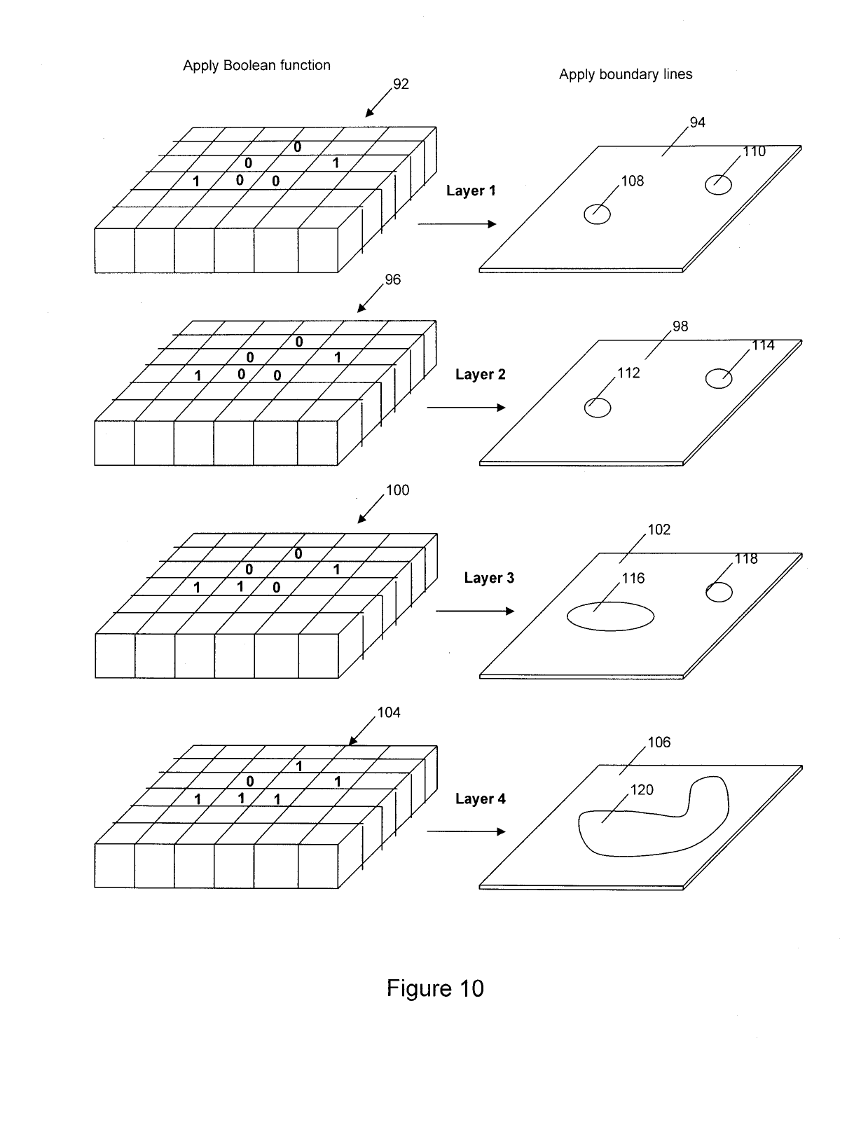

FIGS. 10, 11 and 12 illustrate another example of extracting the geometric features of a body using a Boolean-type function and in particular for a body having a more complex shape.

In FIG. 10, there are four different layers of voxels 92, 96, 100, 104, shown in expanded or exploded form. The layers show the Boolean values. In this case, voxels without a value 1 or 0 indicate that no data is available, or that no data has been collected for these voxels. A Boolean value of 1 represents that the sought-after feature is present. A Boolean value of 0 represents that is confirmed that the sought-after feature is not present. For each layer, a boundary line is drawn around the voxel(s) with a value 1. In Layer 1 (94), there are two separate boundary lines 108, 110, since it has been confirmed that the voxels between the two boundary lines do not contain the sought-after feature. Similarly in Layer 2 (98), there are two separate boundary lines 112 and 114, which may indicate the possibility of two separate bodies. Layer 3 (102) also shows two separate boundary lines 116, 118. In Layer 4 (106), there is a single boundary line 120 which covers a larger area.

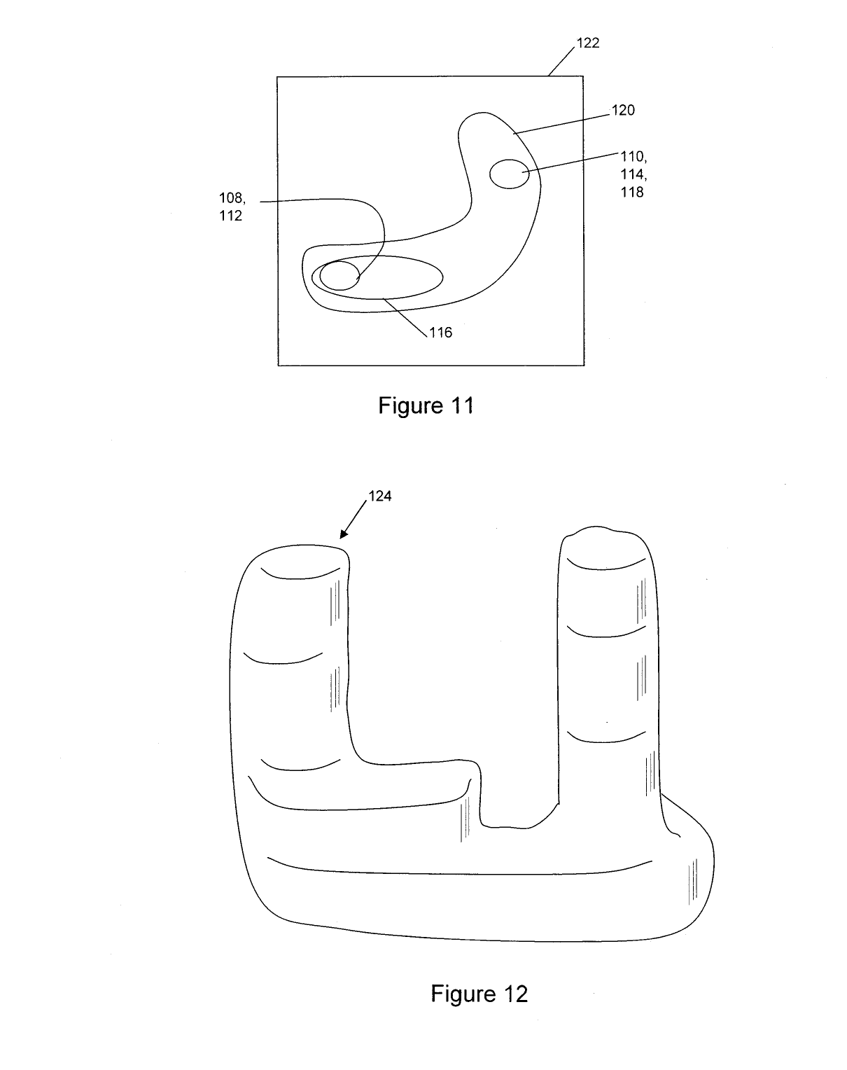

Turning to FIG. 11, the boundary lines 108, 110, 112, 114, 116, 118, 120 are projected onto a common horizontal plane 122. Although boundary lines 110 and 108 do not intersect each other, they both intersect or overlap with boundary line 120. In this way, boundary lines 110 and 108 are considered to form the same body. Therefore, since there is some intersection amongst all the boundary lines, the boundary lines shown in FIGS. 10 and 11 are classified as forming the same body. Based on such classification, a 3D shape 124 of the body is reconstructed using the boundary lines, as shown in FIG. 12.

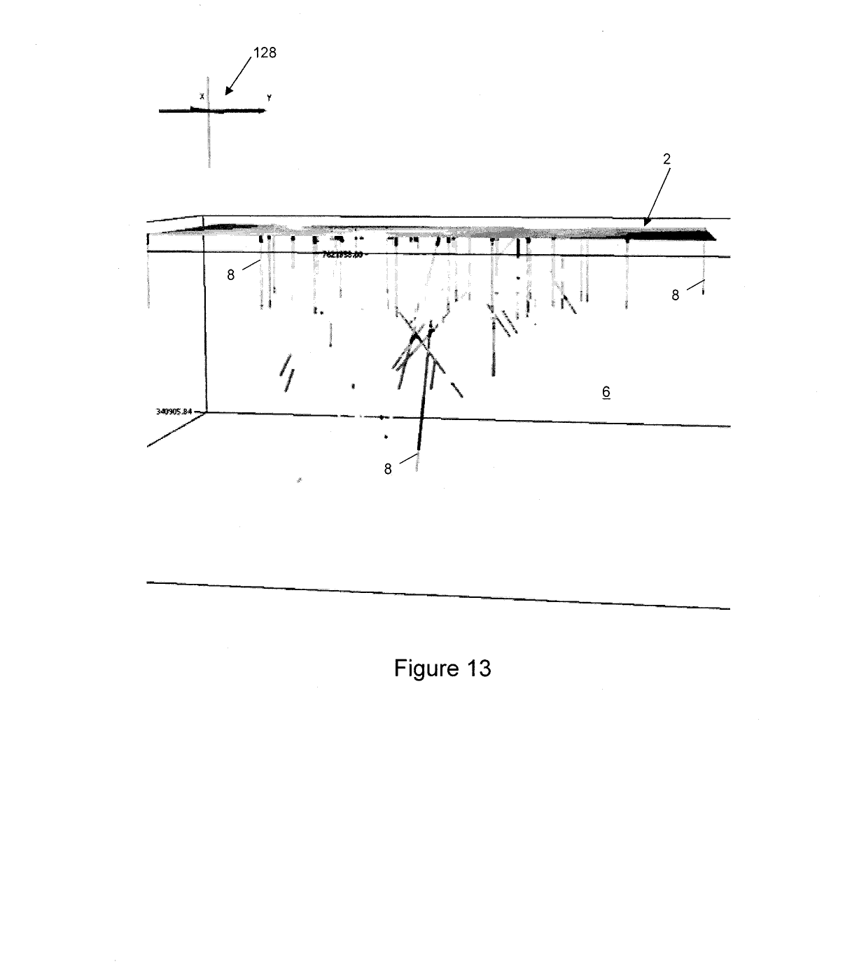

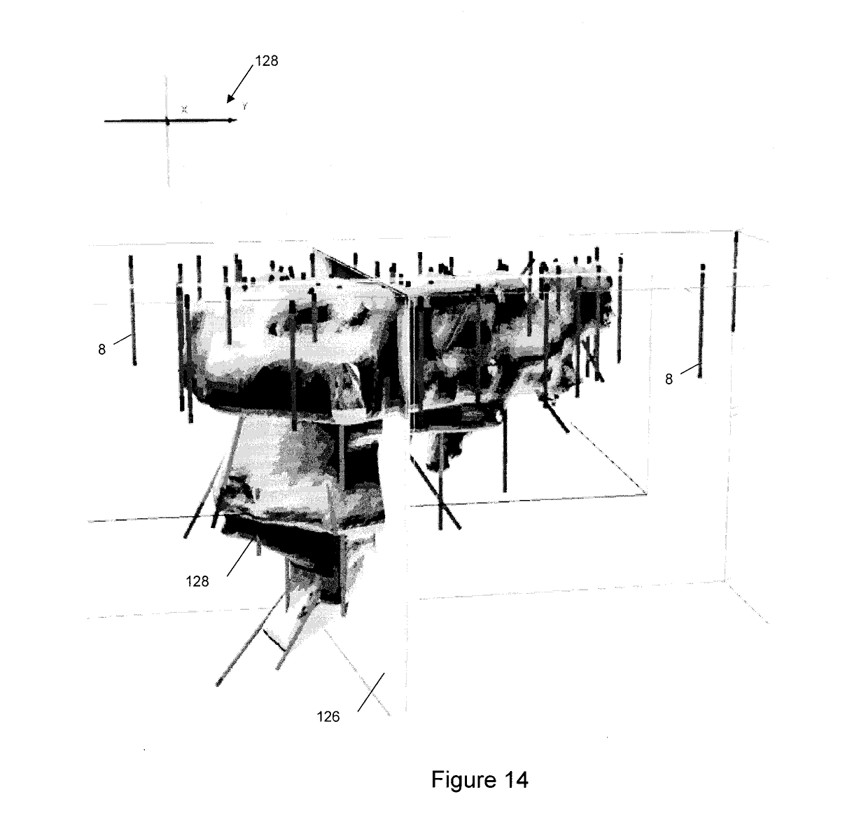

FIGS. 13 and 14 are screenshots shown on the display 318. In particular FIG. 13 show the ground surface 2, the subsurface 6, as well as various drill holes 8. FIG. 14 shows a body of ore which has been calculated using the method described above.

Therefore, in general, a method is provided for identifying a body of material with one or more common characteristics from a data set, the data set corresponding to spatial coordinates and organized into a three-dimensional array of voxels. The method comprises: in a first layer and a second layer of voxels, determining if one or more voxels have the one or more common characteristics; in the first layer and the second layer, defining a first boundary line and a second boundary line respectively around the one or more voxels having the one or more common characteristics; projecting the first and the second boundary lines onto a plane substantially parallel with the first and the second layers; and, if the boundary lines intersect, classifying the boundary lines as part of the same body.

In another aspect, a Boolean function is applied to the one or more voxels to determine if the one or more voxels have the one or more common characteristics. In another aspect, the first boundary line and the second boundary line are defined around the one more voxels associated with a positive Boolean value according to the applied Boolean function. In another aspect, the Boolean function comprises determining if a percentage mass of material within a given voxel is greater than a threshold. In another aspect, the Boolean function comprises determining if a percentage volume of material within a given voxel is greater than a threshold. In another aspect, the Boolean function comprises determining if a given voxel is within a threshold distance from another voxel having one or more known characteristics. In another aspect, the body of material is located below a ground surface. In another aspect, the data set is obtained by one or more drilling cores. In another aspect, the data set is obtained by LiDAR. In another aspect, the method further comprises using at least the first and the second boundary lines to generate a three-dimensional shell representing the body of material. In another aspect, a first boundary line is formed in the first layer by applying an edge detection algorithm around the one or more voxels having the one or more characteristics.

In another embodiment, probabilistic methods may be used to characterize the shape of 3D objects in space which delineate regions which have particular characteristics in common (for example regions of space below the ground which have a concentration of gold ore greater than one ounce per tonne). The interpolation of randomly distributed points over 3D space is important to many applications, including geology and mining. In such applications, geophysical or geochemical parameters, which are typically piecewise-continuous, are assessed. However, the known parameters (e.g. data gained through data collection and experimentation) is typically spatially distributed far away from each other and typically includes a limited number of random points. Such a scenario is common due to the positions of drill-holes. Examples of the parameter to be measured include density, porosity, permeability, etc.

Known methods typically suggest various interpolation “weighted distance” techniques based upon two principal assumptions. A first assumption is that the influence of a certain known data point on the data point which is being estimated is significant only if the known point is located within the limited vicinity of the point which is being estimated. This is generally referred to as the locality assumption. A second assumption is that the influence of a certain known point on the point which is being estimated is inversely proportional to the distance between these points, also referred to as the inverse distance assumption. However, these known methods do not account for the geological structure of the body which may significantly affect the parameter distribution and in particular may define the breakdown surfaces that represent the boundaries of continuous zones. In other words, in scenarios where there are discrete boundaries, or sudden and drastic changes in parameters values, the assumptions do not apply since they relate to continuous or gradual changes in the values.

The proposed interpolation method accounts for the sudden and drastic changes in the values. In geological environments, the method of interpolation for sedimentary type structures uses geological layers (e.g. also called horizons) as a constraint for the selection of known points which are involved in the calculation of the interpolated value. In addition, the proposed method provides a confidence value regarding the interpolated value at each interpolated voxel. The confidence value may be between 0 and 1 or may be represented by a percentage.

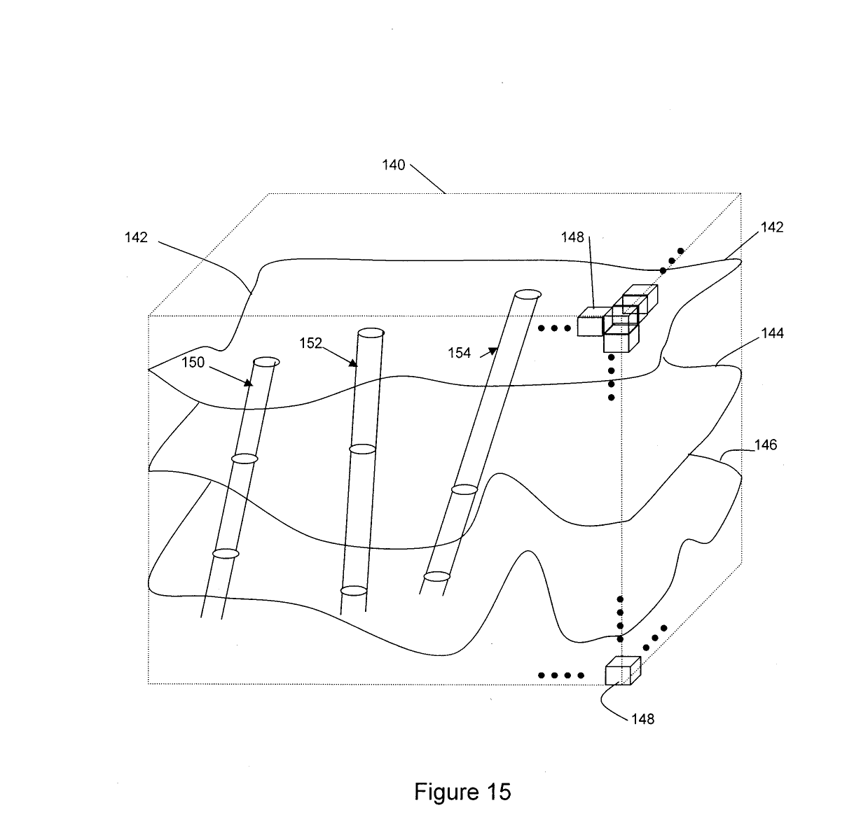

Turning to FIG. 15, a volume of space 140 is provided which includes a number of layer boundaries 142, 144, 146. The space between layer boundaries 142 and 144 is a layer of material having a certain common parameter. The space between layer boundaries 144 and 146 is a layer of material having another common parameter, but in some way different from the first. A number of drill holes 150, 152 and 154 intersect with the different layer boundaries 142, 144, 146. As described above data points are collected at many positions along the drill holes 150, 152, 154, and are mapped onto or associated with spatial coordinates. To better assess the data points, the volume of space 140 is divided into voxels 148. Generally, the interpolation method estimates a parameter value for each voxel, and calculates the level of confidence or confidence interval for the provided estimate.

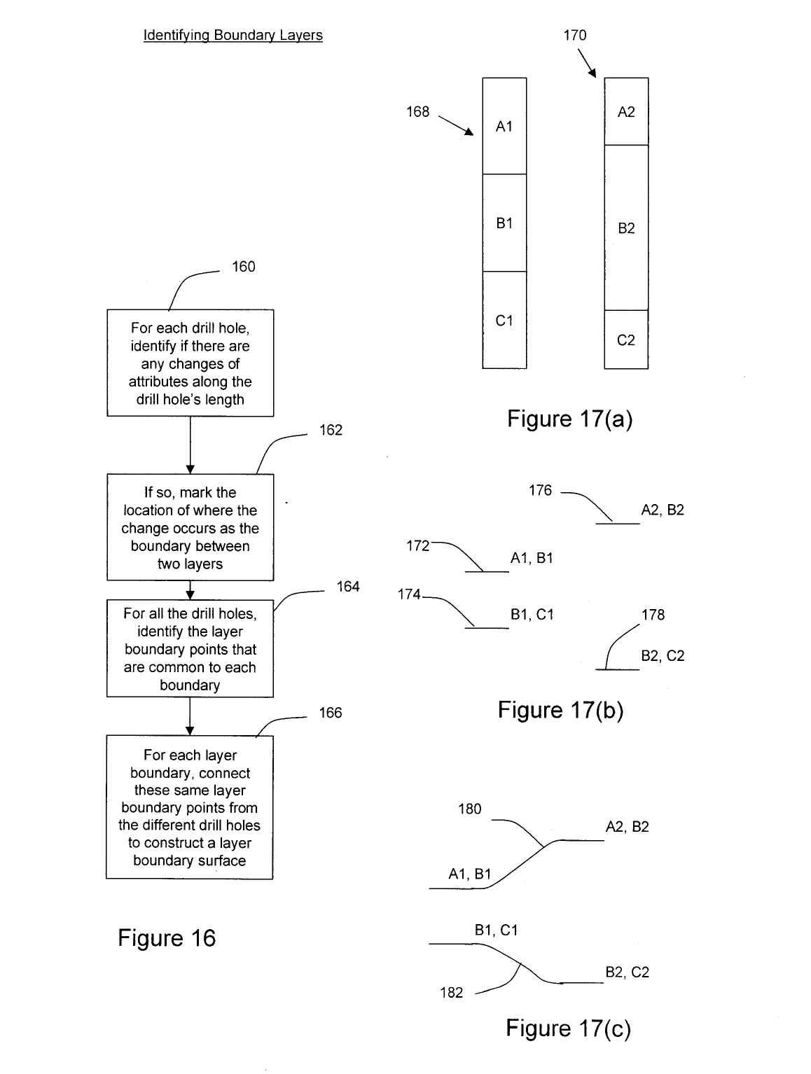

Turning to FIG. 16, an example set of computer executable instructions are provided for identifying the layer boundaries based on the data collected from the drill holes. At block 160, for each drill hole, it is identified if there are any major changes of attributes along the drill hole's length. For example, does the type of rock change from one depth to another? At block 162, if there is a change, the location of where the change occurs is marked as the boundary between two layers. At this stage, there are only layer boundary positions known along the drill holes. In order to develop a layer boundary surface that expands across a larger area (e.g. between the drill holes), then at block 164, for all drill holes, the layer boundary points that are common to each layer boundary are identified. At block 166, these common layer boundary points from the different drill holes are inter-connected to form a layer boundary surface. Delanuay's triangulation algorithm can be used, for example, to construct the layer boundary surface.

FIGS. 17(a), 17(b) and 17(c) illustrate an example according the method described in FIG. 16. In FIG. 17(a) two core samples or drill holes 168, 170 are shown each having three layers. Drill hole 168 has layers A1, B1 and C1. Drill hole 170 has layers A2, B2 and C2. In this example, the prefixes “A”, “B” and “C” denote materials having a certain parameter value. In FIG. 17(b), for drilling hole 168, the layer boundary 172 is marked to separate layers A1 and B1, and the layer boundary 174 is marked to separate layers B1 and C1. Similarly, for drilling hole 170, the layer boundary 176 is marked to separate layers A2 and B2, and the layer boundary 178 is marked to separate layers B2 and C2. In FIG. 17(c), the layer boundary marker points from each of the drill holes 168, 170 are connected to form an extended layer boundary as a surface. Extended layer boundary 180 separates material layers A and B generally, while extended layer boundary 182 separates material layers B and C generally.

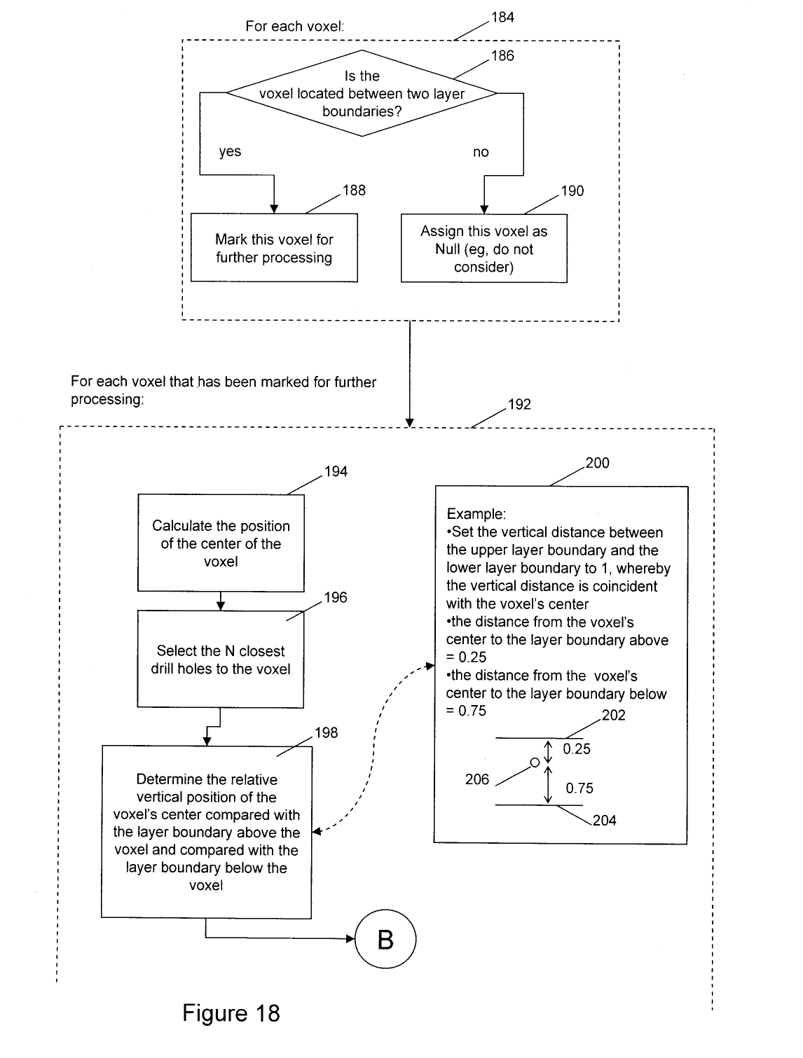

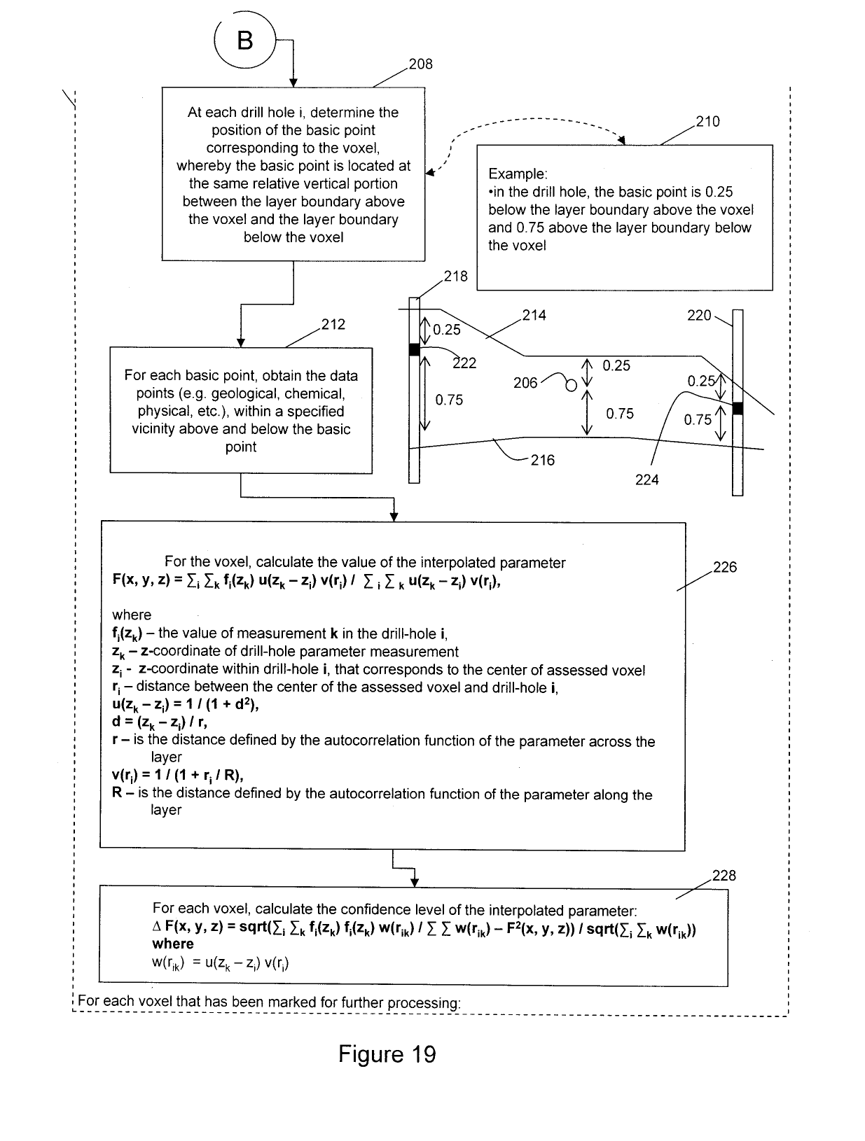

Turning to FIGS. 18 and 19, example computer executable instructions are provided for extracting features based on interpolated data. Such instructions may be part of the probabilistic extraction module 334.

In FIG. 18, at block 184, a set of instructions are provided for each voxel. In particular, for each voxel it is determined if the voxel is located between two layer boundaries (block 186). If so, this voxel is marked or considered for further processing (block 188). Otherwise, this voxel is assigned a null value so that it will not be considered for further processing (block 190).

At block 192, a set of instructions are provided for each of the voxels that have been marked for further processing. In particular, for each of such voxels, the location of the center of the voxel is then calculated (block 194) and the N closest drills to the voxel are identified (block 196). N represents a number greater than or equal to the value 1. At block 198, the computing device 320 determines the relative vertical position of the voxel's center compared with the layer boundary above the voxel and compared with the layer boundary below the voxel. An example of the process in block 198 is described and illustrated in block 200, which shows the voxel's center 206 between an upper layer boundary 202 and a lower layer boundary 204. The vertical distance between the layer boundaries 202, 204 may be set to 1, whereby the vertical distance is coincident with the voxel's center 206. In this example, the center 206 is positioned one-quarter of the way down from the upper boundary 202. In other words, the distance from the voxel's center 206 to the layer boundary 202 above is 0.25, and the distance from the voxel's center 206 to the layer boundary 204 below is 0.75. As indicated by circle B, the method of FIG. 18 continues to FIG. 19.

At block 208, at each drill hole i, where i≦N, the computing device 320 determines the position of the basic point corresponding to the voxel. The basic point is located at the same relative vertical position between the layer boundary above the voxel and the layer boundary below the voxel. An example is provided in block 210 to explain the process of block 208. In keeping with the previous example, in the drill hole, the basic point is 0.25 below the upper layer boundary and 0.75 above the lower layer boundary. For example, the voxel's center 206 is located 0.25 below the upper boundary 214. Therefore, in drill hole 218, the basic point 222 is also located 0.25 below the upper layer boundary 218. It can be appreciated that 0.25 is a ratio or normalized height characterizing the vertical distance between the upper boundary 214 and the lower boundary 216. Similarly, in the drill hole 220, the basic point 224 is located 0.25 below the upper layer boundary 214.

At block 212, for each basic point, the data points within the specified vicinity above and below the basic point are obtained. As described earlier, the data points may related to geological, chemical or physical attributes.

At block 226, the following equation is used to determine the estimated or interpolated value for the voxel. In particular, at the centre position (e.g. at coordinates x,y,z) of the voxel, the interpolated parameter is calculated as the value F(x,y,z).

F(x,y,z)=ΣᵢΣₖfᵢ(zₖ)u(zₖ−zᵢ)v(rᵢ)/ΣᵢΣₖu(zₖzᵢ)v(rᵢ) Equation 1:

Where:

N—is a pre-chosen number of drill holes closest to the current voxel being assessed

nᵢ—is the number of data points in the vicinity of the i^{th} drill hole's basic point

i—is a value from one to N

k—is a value from one to nᵢ

zᵢ—is the Z coordinate at the basic point of the i^{th} drill hole

zₖ—is the Z coordinate at the k th point in the vicinity of the i^{th} drill hole's basic point

fᵢ(zₖ)—is the value at the k th point in the vicinity of the i^{th} drill hole's basic point

rᵢ—is the distance between the voxel centre and the i^{th} drill hole's basic point (zₖ−zᵢ)—is the distance between the drill hole basic point and the k^{th} point in its vicinity

u(zₖ−zᵢ)=1/(1+d²)

d=(zₖ−zᵢ)/r

r—is the distance defined by the correlation function of the parameter across the layer (e.g. for horizontal layers it would be the maximum vertical distance beyond which points should not be considered as noticeably correlating with each other)

v(rᵢ)=1/(1+rᵢ/R)

R—is the distance defined by the correlation function of the parameter along the layer. (e.g. for horizontal layers the distance R would be the maximum horizontal distance beyond which points should not be considered as noticeably correlating with each other)

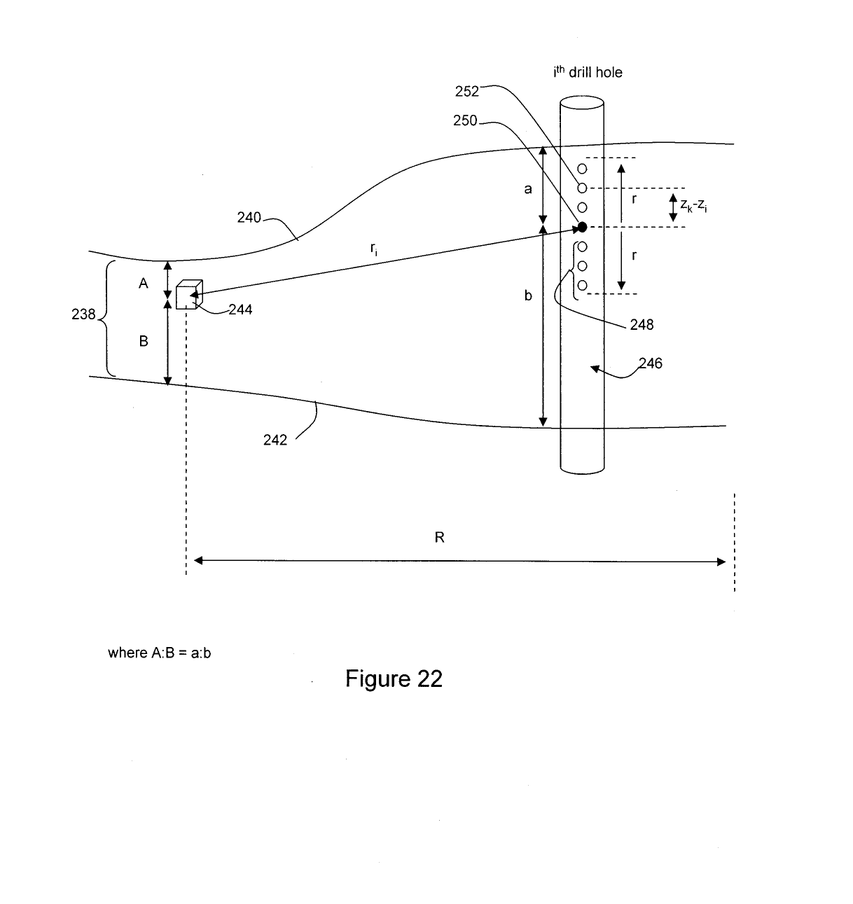

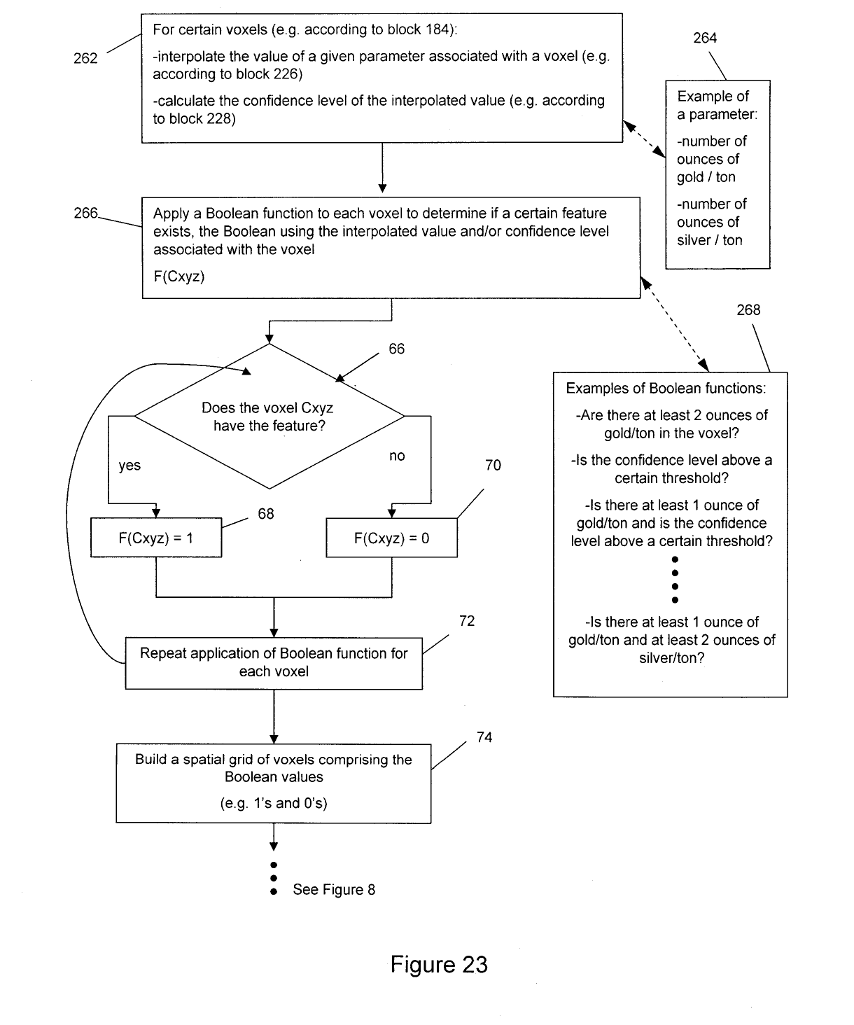

The above parameters of Equation 1, for determining the estimated or interpolated value for the voxel, are shown in FIG. 22. An example of the layers, parameters, voxel and drill hole are shown in FIG. 22. In particular, a layer 238 is defined by a first layer boundary 240 and a second layer boundary 242. A voxel 244 (e.g. the centre of the voxel) is shown positioned a distance of A units from the first layer boundary 240, and a distance of B units from the second layer boundary 242. Out of the N drill holes closest to the voxel 244, or the voxel's centre, one the N drill holes is shown as the i^{th} drill hole 246, where i is an arbitrary number between 1 and N. The position of a basic point 250 in the drill hole 246 is determined by its relative position between the layer boundaries 240 and 242. In particular, the basic point 250 should be positioned a distance of “a” units from the first layer boundary 240 and a distance of “b” units from the second layer boundary 242, whereby the ratio of A:B=a:b.

Continuing with the example in FIG. 22, within the drill hole 246, a number of known data points 248 (e.g. data collected from scientists or through tests) are considered if the data points are within a distance range of “r” units from the basic point 250. The total number of the known data points within the vicinity (e.g. within the range of “r” units) of the basic point 250 is represented by nᵢ, and one data point, of the nᵢ data points, is referred to as the k^{th} data point 252. The vertical distance between the basic point 250 and the k^{th} data point 252 is calculated by (zₖ−zᵢ). As can be seen in Equation 1, the value measured at the k^{th} data point is fᵢ(zₖ), which is weighted or adjusted by the values u(zₖ−zᵢ) and v(rᵢ). In particular, from the function u(zₖ−zᵢ), in general, the closer the k^{th} data point 252 is located to the basic point 250 of the i^{th} drill hole 246, the more influence or weight the value fᵢ(zₖ) of the k^{th} data point 252 is given to the interpolated parameter of the voxel 244. The further away the k^{th} data point 252 is located from the basic point 250 of the i^{th} drill hole 246, the less influence or weight the value fᵢ(zₖ) of k^{th} data point 252 has on the value of the voxel's interpolated parameter. For known data points located beyond the value of “r” units away from the basic point 250, the influence of such data points is greatly diminished, for example, to a point that such data points are not considered.

Similarly, when considering the function v(rᵢ)=1/(1+rᵢ/R), in general, the Closer the i^{th} drill hole 246 is to the voxel 244, the more influence or weight the value fᵢ(zₖ) of the k^{th} data point 252 is given to the interpolated parameter of the voxel 244. Conversely, the further away the i^{th} drill hole 246 is from the voxel 244, the less influence or weight the value fᵢ(zₖ) of k^{th} data point 252 has on the value of the voxel's interpolated parameter. For known data points in a drill hole that is located beyond the value of “R” units away from the voxel 244, the influence of such data points is greatly diminished, for example, to a point that such data points are not considered.

A particular advantage of this equation and method is that it produces a 3D model by propagating the values of a volumetric function (e.g. ore grade, porosity, density, etc.) not only along and parallel to the undulations of the layers but also proportionally spaced between the layer boundary surfaces. This is particularly desirable for models of volumes such as sedimentary geological deposits whose form naturally follows a layered structure having been formed sub-layer by sub-layer over millions of years and whose layered structure may have been partially bent and deformed.

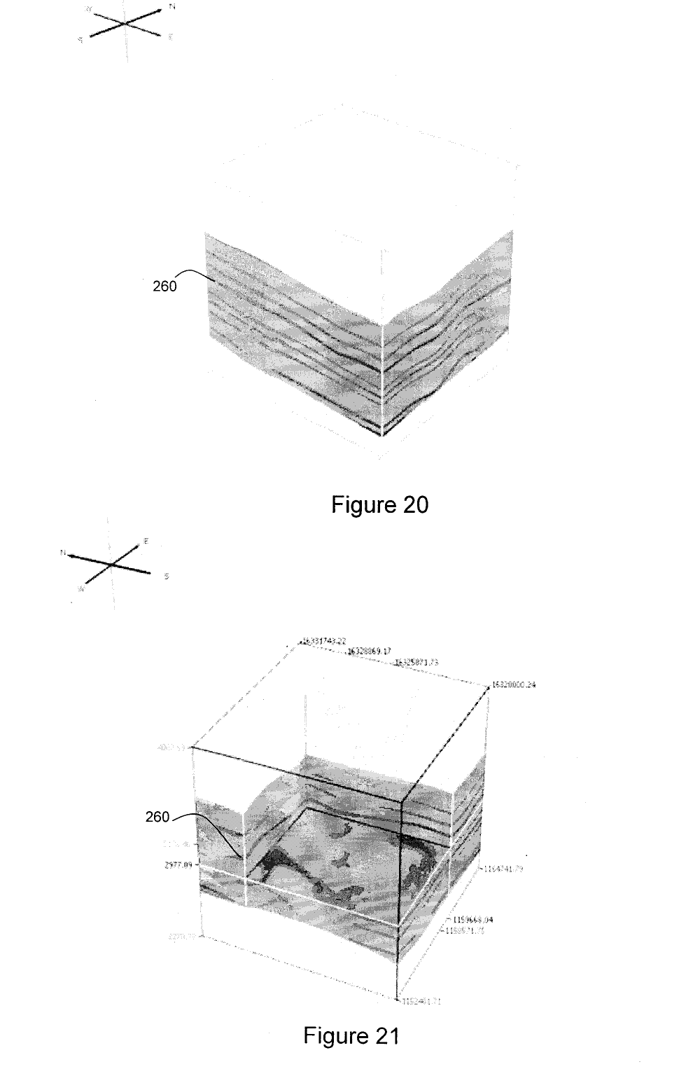

Note that the distances R and r, which are defined by the correlation functions along and across the layers, describe the expected limits in data correlation behavior in the directions parallel and perpendicular to the layers and layer boundaries. In other words, based on the known values of a certain attribute based on the known data points (e.g. those collected from the drill holes), the known value can be used to interpolate values for the same attributes across a wide area that is spread across the layer, and parallel to the layer boundaries. For example, the interpolated values of different attributes can be seen in the striations 260 which extend across the volumes of space in FIGS. 20 and 21.

The mathematical equations themselves could differ depending on how the continuity of the material being interpolated is expected to change throughout the space of interest. For example a geological volcanic plug of kimberlite might have a very linear correlation function in the vertical direction but a more exponential correlation function in horizontal directions radiating in a circle from the center of the volcanic plug. To accommodate this, or other different applications, the equations for weighting the known values in the horizontal and vertical directions (or in other angled planes), may be modified relative to one another using known mathematical relationships.

Turning back to FIG. 19, at block 228, for each voxel, the confidence level, or confidence interval, of the interpolated parameter F(x,y,z) is also calculated. The confidence level ΔF(x, y, z) is calculated according to the equation below.

ΔF(x,y,z)=sqrt(ΣᵢΣₖfᵢ(zₖ)fᵢ(zₖ)w(rᵢₖ)/ΣᵢΣₖw(rᵢₖ)−F²(x,y,z))/sqrt(ΣᵢΣₖw(rᵢₖ)) Equation 2:

where w(rᵢₖ)=u(zₖ−zᵢ)v(rᵢ).

The confidence level is calculated using a least squares determination of the standard deviations of all the data point values fᵢ(zₖ), which are used in the calculation from the interpolated value F(x, y, z). Other known methods for determining the confidence level of interpolated data may be used.

In particular, Equation 2 also uses the weight coefficients u(zₖ−zᵢ) and v(rᵢ) which are based on the distances “r” and “R” and are defined by the correlation function in the direction between the layers (e.g. vertical) and along the layers (e.g. horizontal). This generally applies the same principle as Equation 1 in following the overall layered structure of the region being calculated

It can therefore be seen that the above described method provides an interpolated value and a confidence level associated with each voxel.

Therefore, in general, a method is provided for determining a value of a parameter, the value associated with a spatial coordinate. The method comprises: upon determining the spatial coordinate is located in a layer defined by at least a first layer boundary and a second layer boundary, determining a distance ratio of the spatial coordinate's distance to the first layer boundary and to the second layer boundary; at a drill hole extending across the first layer boundary and the second layer boundary, selecting a basic point located in the layer and positioned at the distance ratio relative to the first layer boundary and the second layer boundary; and determining the value associated with the spatial coordinate using a known value of the parameter at a known data point in the drill hole, the known value having a higher influence on determining the value if the known data point is closer to the basic point and if the drill hole is closer to the spatial coordinate.

In another aspect, the known value of the parameter at the known data point is obtained from a core sample of the drill hole. In another aspect, the first layer boundary and the second layer boundary is computed by detecting changes of one or more attributes of material located along the length of one or more drill holes. In another aspect, the one or more attributes of the material comprises rock type. In another aspect, Delaunay's triangulation algorithm is used to compute the first layer boundary and the second layer boundary. In another aspect, the method further comprises computing a confidence interval of the determined value of the parameter. In another aspect, the spatial coordinate is located at the center of a voxel. In another aspect, the method further comprises characterising the voxel by the determined value of the parameter.

In another aspect, the value of the parameter is determined according to F(x, y, z)=ΣᵢΣₖfᵢ(zₖ) u(zₖ−zᵢ) v(r)/ΣᵢΣₖ u(zₖ−zᵢ) v(rᵢ), wherein:

(x, y, z) is the spatial coordinate;

N is a predetermined number of drill holes closest to the voxel;

i is a value from 1 to N;

nᵢ is the number of known data points associated with known values of the parameter, the known data points located within a predetermined vicinity of an i th drill hole's basic point; k is a value from 1 to nᵢ;

zᵢ is a Z coordinate at the basic point of the i th drill hole;

zₖ is a Z coordinate at the k th point in the vicinity of the i th drill hole's basic point;

fᵢ(zₖ) is the known value at the k th point in the vicinity of the i th drill hole's basic point;

rᵢ is a distance between the center of the voxel and the i th drill hole's basic point;

u(zₖ−zᵢ)=1/(1+d²)

d=(zₖ−zᵢ)/r

r is a predetermined distance substantially perpendicular to the layer;

v(rᵢ)=1/(1+rᵢ/R); and

R is a predetermined distance substantially parallel with the layer.

In another aspect, a confidence interval of the determined value of the parameter is computed according to

ΔF(x,y,z)=sqrt(ΣᵢΣₖfᵢ(zₖ)fᵢ(zₖ)w(rᵢₖ)/ΣᵢΣₖw(rᵢₖ)−F²(x,y,z))/sqrt(ΣᵢΣₖw(rᵢₖ)), and

wherein w(rᵢₖ)=u(zₖ−zᵢ)v(rᵢ).

In another aspect, the layer is a geological layer. In another aspect, the parameter is at least one of geological parameter, chemical parameter or physical parameter. In another aspect, the method further comprises using the determined value of the parameter to identify a body of material with one or more common characteristics from a data set, the data set corresponding to spatial coordinates and organized into a three-dimensional array of voxels.

The above systems and methods for interpolating a value of a parameter, whereby the value is associated with a spatial coordinate, and for identifying a body of common material from a data set, whereby the data set corresponds to spatial coordinates and is organized into a three-dimensional array of voxels, can be combined. In other words, the approaches of both the Boolean extraction module 332 and the probabilistic extraction module 334 can be combined.

Turning to FIG. 23, at block 262, for a voxel, the value of a given parameter is interpolated and the confidence level of the interpolated value is also calculated. This process is applied to voxels located within a given space. This process, for example, uses the principles described above with respect to FIGS. 18 and 19. In particular, only voxels that meet certain requirements (see block 184) are considered. Further, the interpolation of the certain parameter is calculated according to block 226 and the confidence level is calculated according to block 228. In one example (block 264), the parameter to be interpolated for a number of voxels in a given space is the number of ounces of gold per ton. Additionally, another parameter can be interpolated, such as the number of ounces of silver per ton. In other words, multiple parameters (e.g. mass of material A, density of material C, pH level) can be interpolated for a given voxel.

Upon determining the interpolated values, and optionally confidence levels, of one or more parameters associated with a number of voxels, a Boolean function is applied to the voxels (block 266). The Boolean function will determine if a certain feature exists or does not exist. The Boolean function is at least associated in part with either the previously determined interpolated value of the parameter or the confidence level, or both. It is possible that the Boolean function may be related to multiple parameters associated with a voxel. At block 268, non-limiting examples of Boolean functions are provided and include whether or not there are at least two ounces of gold/ton. Another example of a Boolean function is whether or not the confidence level is above a certain threshold. Another example of a Boolean function is whether or not there is at least one ounce of gold/ton AND the confidence level is above a certain threshold. Yet another example of a Boolean function is whether or not there is at least one ounce of gold/ton AND at least two ounces of silver/ton.

Continuing with FIG. 23, the Boolean values (e.g. 1 or 0; yes or no; true or false; etc.) associated with each voxel are calculated (blocks 66, 68, 70, 72). Using the Boolean values in each layer of voxels, the shape of a body can be determined and displayed. This uses the principles described with respect to FIGS. 8 and 9.

It can therefore be understood that, based on a few known data points in a point cloud, other data points can be interpolated for a given parameter. Thus, a greater number of data points in the point cloud is known. Using the greater number of data points, a Boolean function, related to the given parameter, can be used to extract more detailed features. In particular, based on the Boolean values, a shape of a body having the characteristic(s) defined by the Boolean function can be constructed in a layered manner.

The steps or operations in the flow charts described herein are just for example. There may be many variations to these steps or operations without departing from the spirit of the invention or inventions. For instance, the steps may be performed in a differing order, or steps may be added, deleted, or modified.

While the basic principles of this invention or these inventions have been herein illustrated along with the embodiments shown, it will be appreciated by those skilled in the art that variations in the disclosed arrangement, both as to its details and the organization of such details, may be made without departing from the spirit and scope thereof. Accordingly, it is intended that the foregoing disclosure and the showings made in the drawings will be considered only as illustrative of the principles of the invention or inventions, and not construed in a limiting sense.

1. A method is provided for identifying a body of material with one or more common characteristics from a data set, the data set corresponding to spatial coordinates and organized into a three-dimensional array of voxels, the method comprising:
in a first layer and a second layer of voxels, determining if one or more voxels have the one or more common characteristics;
in the first layer and the second layer, defining a first boundary line and a second boundary line respectively around the one or more voxels having the one or more common characteristics;
projecting the first and the second boundary lines onto a plane substantially parallel with the first and the second layers; and,
if the boundary lines intersect, classifying the boundary lines as part of the same body.

2. The method of claim 1 wherein a Boolean function is applied to the one or more voxels to determine if the one or more voxels have the one or more common characteristics.

3. The method of claim 2 wherein the first boundary line and the second boundary line are defined around the one more voxels associated with a positive Boolean value according to the applied Boolean function.

4. The method of claim 2 wherein the Boolean function comprises determining if a percentage mass of material within a given voxel is greater than a threshold.

5. The method of claim 2 wherein the Boolean function comprises determining if a percentage volume of material within a given voxel is greater than a threshold.

6. The method of claim 2 wherein the Boolean function comprises determining if a given voxel is within a threshold distance from another voxel having one or more known characteristics.

7. The method of claim 1 wherein the body of material is located below a ground surface.

8. The method of claim 1 wherein the data set is obtained by one or more drilling cores.

9. The method of claim 1 wherein the data set is obtained by LiDAR.

10. The method of claim 1 further comprising using at least the first and the second boundary lines to generate a three-dimensional shell representing the body of material.

11. The method of claim 1 wherein a first boundary line is formed in the first layer by applying an edge detection algorithm around the one or more voxels having the one or more characteristics.

12. A computer readable medium comprising computer executable instructions for identifying a body of material with one or more common characteristics from a data set, the data set corresponding to spatial coordinates and organized into a three-dimensional array of voxels, the computer executable instructions comprising:
in a first layer and a second layer of voxels, determining if one or more voxels have the one or more common characteristics;
in the first layer and the second layer, defining a first boundary line and a second boundary line respectively around the one or more voxels having the one or more common characteristics;
projecting the first and the second boundary lines onto a plane substantially parallel with the first and the second layers; and,
if the boundary lines intersect, classifying the boundary lines as part of the same body.

13. The computer readable medium of claim 12 wherein a Boolean function is applied to the one or more voxels to determine if the one or more voxels have the one or more common characteristics.

14. The computer readable medium of claim 13 wherein the first boundary line and the second boundary line are defined around the one more voxels associated with a positive Boolean value according to the applied Boolean function.

15. The computer readable medium of claim 13 wherein the Boolean function comprises determining if a percentage mass of material within a given voxel is greater than a threshold.

16. The computer readable medium of claim 13 wherein the Boolean function comprises determining if a percentage volume of material within a given voxel is greater than a threshold.

17. The computer readable medium of claim 13 wherein the Boolean function comprises determining if a given voxel is within a threshold distance from another voxel having one or more known characteristics.

18. The computer readable medium of claim 12 wherein the body of material is located below a ground surface.

19. The computer readable medium of claim 12 wherein the data set is obtained by one or more drilling cores.

20. The computer readable medium of claim 12 wherein the data set is obtained by LiDAR.

21. The computer readable medium of claim 12 further comprising using at least the first and the second boundary lines to generate a three-dimensional shell representing the body of material.

22. The computer readable medium of claim 12 wherein a first boundary line is formed in the first layer by applying an edge detection algorithm around the one or more voxels having the one or more characteristics.

23. A method for determining a value of a parameter, the value associated with a spatial coordinate, the method comprising:
upon determining the spatial coordinate is located in a layer defined by at least a first layer boundary and a second layer boundary, determining a distance ratio of the spatial coordinate's distance to the first layer boundary and to the second layer boundary;
at a drill hole extending across the first layer boundary and the second layer boundary, selecting a basic point located in the layer and positioned at the distance ratio relative to the first layer boundary and the second layer boundary; and
determining the value associated with the spatial coordinate using a known value of the parameter at a known data point in the drill hole, the known value having a higher influence on determining the value if the known data point is closer to the basic point and if the drill hole is closer to the spatial coordinate.

24. The method of claim 23 wherein the known value of the parameter at the known data point is obtained from a core sample of the drill hole.

25. The method of claim 23 wherein the first layer boundary and the second layer boundary is computed by detecting changes of one or more attributes of material located along the length of one or more drill holes.

26. The method of claim 25 wherein the one or more attributes of the material comprises rock type.

27. The method of claim 23 wherein Delaunay's triangulation algorithm is used to compute the first layer boundary and the second layer boundary.

28. The method of claim 23 further comprising computing a confidence interval of the determined value of the parameter.

29. The method of claim 23 wherein the spatial coordinate is located at the center of a voxel.

30. The method of claim 29 further comprising characterising the voxel by the determined value of the parameter.

31. The method of claim 29 wherein the value of the parameter is determined according to
F(x,y,z)=ΣᵢΣₖfᵢ(zₖ)u(zₖ−zᵢ)v(rᵢ)/ΣᵢΣₖu(zₖzᵢ)v(rᵢ), wherein
(x, y, z) is the spatial coordinate;
N is a predetermined number of drill holes closest to the voxel;
i is a value from 1 to N;
nᵢ is the number of known data points associated with known values of the parameter, the known data points located within a predetermined vicinity of an i^{th} drill hole's basic point;
k is a value from 1 to nᵢ;
zᵢ is a Z coordinate at the basic point of the i^{th} drill hole;
zₖ is a Z coordinate at the k^{th} point in the vicinity of the i^{th} drill hole's basic point;
fᵢ(zₖ) is the known value at the k^{th} point in the vicinity of the i^{th} drill hole's basic point;
rᵢ is a distance between the center of the voxel and the i^{th} drill hole's basic point;
u(zₖ−zᵢ)=1/(1+d²)
d=(zₖ−zᵢ)/r
r is a predetermined distance substantially perpendicular to the layer;
v(rᵢ)=1/(1+rᵢ/R); and
R is a predetermined distance substantially parallel with the layer.

32. The method of claim 31 wherein a confidence interval of the determined value of the parameter is computed according to
ΔF(x,y,z)=sqrt(ΣᵢΣₖfᵢ(zₖ)fᵢ(zₖ)w(rᵢₖ)/ΣᵢΣₖw(rᵢₖ)−F²(x,y,z))/sqrt(ΣᵢΣₖw(rᵢₖ)),
and wherein w(rᵢₖ)=u(zₖ−zᵢ)v(rᵢ).

33. The method of claim 23 wherein the layer is a geological layer.

34. The method of claim 23 wherein the parameter is at least one of geological parameter, chemical parameter or physical parameter

35. The method of claim 23 further comprising using the determined value of the parameter to identify a body of material with one or more common characteristics from a data set, the data set corresponding to spatial coordinates and organized into a three-dimensional array of voxels.

36. A computer readable medium comprising computer executable instructions for determining a value of a parameter, the value associated with a spatial coordinate, the computer executable instructions comprising:
upon determining the spatial coordinate is located in a layer defined by at least a first layer boundary and a second layer boundary, determining a distance ratio of the spatial coordinate's distance to the first layer boundary and to the second layer boundary;
at a drill hole extending across the first layer boundary and the second layer boundary, selecting a basic point located in the layer and positioned at the distance ratio relative to the first layer boundary and the second layer boundary; and
determining the value associated with the spatial coordinate using a known value of the parameter at a known data point in the drill hole, the known value having a higher influence on determining the value if the known data point is closer to the basic point and if the drill hole is closer to the spatial coordinate.

37. The computer readable medium of claim 36 wherein the known value of the parameter at the known data point is obtained from a core sample of the drill hole.

38. The computer readable medium of claim 36 wherein the first layer boundary and the second layer boundary is computed by detecting changes of one or more attributes of material located along the length of one or more drill holes.

39. The computer readable medium of claim 38 wherein the one or more attributes of the material comprises rock type.

40. The computer readable medium of claim 36 wherein Delaunay's triangulation algorithm is used to compute the first layer boundary and the second layer boundary.

41. The computer readable medium of claim 36 further comprising computing a confidence interval of the determined value of the parameter.

42. The computer readable medium of claim 36 wherein the spatial coordinate is located at the center of a voxel.

43. The computer readable medium of claim 42 further comprising characterising the voxel by the determined value of the parameter.

44. The computer readable medium of claim 42 wherein the value of the parameter is determined according to
F(x,y,z)=ΣᵢΣₖfᵢ(zₖ)u(zₖ−zᵢ)v(rᵢ)/ΣᵢΣₖu(zₖzᵢ)v(rᵢ), wherein
(x, y, z) is the spatial coordinate;
N is a predetermined number of drill holes closest to the voxel;
i is a value from 1 to N;
nᵢ is the number of known data points associated with known values of the parameter, the known data points located within a predetermined vicinity of an i^{th} drill hole's basic point;
k is a value from 1 to nᵢ;
zᵢ is a Z coordinate at the basic point of the i^{th} drill hole;
zₖ is a Z coordinate at the k^{th} point in the vicinity of the i^{th} drill hole's basic point;
fᵢ(zₖ) is the known value at the k^{th} point in the vicinity of the i^{th} drill hole's basic point;
rᵢ is a distance between the center of the voxel and the i^{th} drill hole's basic point;
u(zₖ−zᵢ)=1/(1+d²)
d=(zₖ−zᵢ)/r
r is a predetermined distance substantially perpendicular to the layer;
v(rᵢ)=1/(1+rᵢ/R); and
R is a predetermined distance substantially parallel with the layer.

45. The computer readable medium of claim 44 wherein a confidence interval of the determined value of the parameter is computed according to
ΔF(x,y,z)=sqrt(ΣᵢΣₖfᵢ(zₖ)fᵢ(zₖ)w(rᵢₖ)/ΣᵢΣₖw(rᵢₖ)−F²(x,y,z))/sqrt(ΣᵢΣₖw(rᵢₖ)),
and wherein w(rᵢₖ)=u(zₖ−zᵢ)v(rᵢ).

46. The computer readable medium of claim 36 wherein the layer is a geological layer.

47. The computer readable medium of claim 36 wherein the parameter is at least one of geological parameter, chemical parameter or physical parameter

48. The computer readable medium of claim 36 further comprising using the determined value of the parameter to identify a body of material with one or more common characteristics from a data set, the data set corresponding to spatial coordinates and organized into a three-dimensional array of voxels.
